(19) United States
(12) Patent Application Publication
(10) Pub. No.: US 2009/0014557 A1
(43) Pub. Date: Jan. 15, 2009

(54) Flow Reservoir for a Paint Spray Gun

(76) Inventors: Ewald Schmon, Grafenberg (DE); Peter Dettlaff, Remseck (DE)

Correspondence Address: Fleit Gibbons Gutman Bongini & Bianco PL, 21355 EAST DIXIE HIGHWAY, SUITE 115, MIAMI, FL, 33180, US

(21) Appl. No.: 10/597,159

(22) PCT Filed: Jan. 18, 2005
(86) PCT No.: PCT/EP2005/000437

§ 371 Date: Jan. 9, 2007

(30) Foreign Application Priority Data
Jan. 22, 2004 (DE) 10 2004 003 438.9

(51) Int. Cl. B05B 7/24

(52) U.S. Cl. 239/302

(57) ABSTRACT

The invention relates to a flow reservoir for a paint spray gun with a bowl-shaped container (1), a cover (2) that can be set on the container (1), and an attachment part (3) for direct fixing of the flow reservoir to the paint spray gun. The flow reservoir is distinguished in that the attachment part (3) consists of a connector (5) formed directly on the cover (2) with a screw-wedge element (8) for direct quick-connect attachment of the flow reservoir to the paint spray gun.

### FILED OF THE INVENTION

The invention relates to a flow reservoir for a paint spray gun.

### BACKGROUND OF THE INVENTION

Conventional flow reservoirs for paint spray guns typically have a bowl-shaped container, whose bottom side has an opening with an attachment part for detachable fastening of the container on the upper side of the paint spray gun. The attachment part typically consists of a connector that is inserted into the container floor and that has an external thread for screwing into a corresponding threaded opening on the upper side of the paint spray gun. The bowl-shaped container is usually closed on its upper side by a suitable cover, which should prevent undesired paint leakage. However, the production of such flow reservoirs with attachment parts manufactured separately and then connected to the container is relatively complicated, and is associated with correspondingly high costs.

From WO 01/12337 A1, flow reservoirs are already known that include a bowl-shaped container and a cover that can be set on this container with a hollow cylindrical attachment part. In these known flow reservoirs, however, the container cover with the cylindrical attachment part cannot be attached directly to the paint spray gun. Here, an additional adapter tailored to the attachment part is required for attaching the flow reservoir to the paint spray gun.

### SUMMARY OF THE INVENTION

The task of the invention is to create a flow reservoir of the type mentioned in the introduction, which can be manufactured economically, and which can be attached quickly and easily to a paint spray gun without an additional adapter.

This task is achieved by a flow reservoir with the features of Claim 1. Preferred configurations and advantageous refinements of the invention are the objects of the subordinate claims.

One essential advantage of the flow reservoir according to the invention is that it consists of two parts that are easy to manufacture. The flow reservoir can be attached easily and quickly to the paint spray gun without an additional adapter by means of the screw-wedge element located on the cover, and can also be removed again from this gun quickly. The flow reservoir, which can be produced economically, can be filled easily and can be used either as a one-time reservoir, as a reusable container, or also as a storage container for leftover paints or lacquers.

In one preferred configuration, the screw-wedge element is formed by a groove with a screw surface extending diagonally in the circumferential direction. This screw surface is led into engagement with a corresponding counter-surface on a shoulder or projection of the paint spray gun. However, the screw-wedge element can also be configured as a wedge-shaped or screw-shaped projection, which is led into engagement with a corresponding groove on the paint spray gun.

In another advantageous configuration, the connector contains an additional thread for screwing into a conventional internal thread in an inlet opening of the paint spray gun. Thus, the flow reservoir can also be used for paint spray guns that do not have a quick-connect attachment corresponding to the screw-wedge element, but instead a conventional connection with an internal thread.

### BRIEF DESCRIPTION OF THE DRAWINGS

Other details and advantages of the invention result from the following description of a preferred embodiment, with reference to the drawing. Shown are:

FIG. 1 a flow reservoir according to the invention in section;

FIG. 2 a section view along the line A-A of FIG. 1;

FIG. 3 a detail view of region X of FIG. 1;

FIG. 4 a view of the bowl-shaped container and the cover of a flow reservoir with a quick-connect thread for screwing the cover onto the container;

FIG. 5 a detail view of region Y of FIG. 4;

FIG. 6 a detail view of region W of FIG. 4; and

FIG. 7 a section view along the line A-A of FIG. 4.

### DETAILED DESCRIPTION OF THE INVENTION

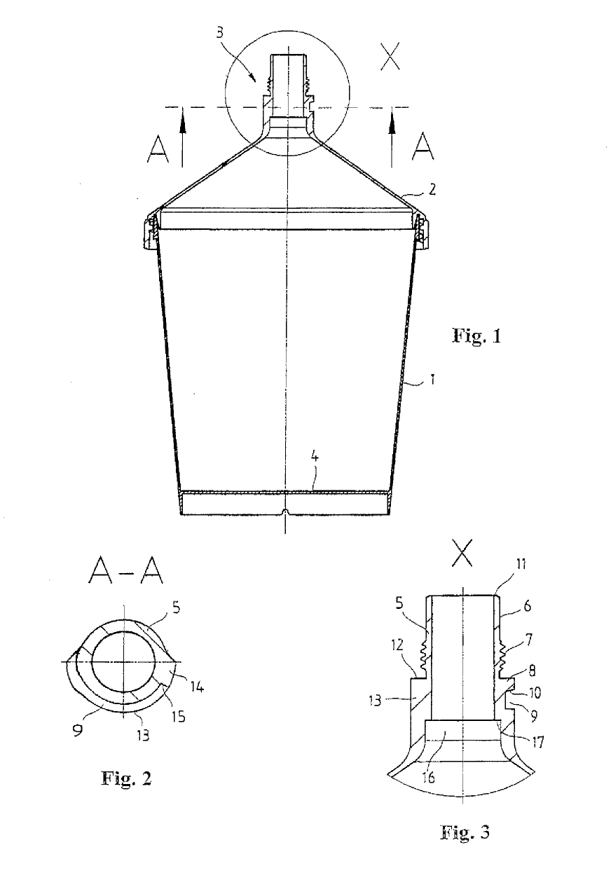

The flow reservoir shown in FIG. 1 for a paint spray gun contains a bowl-shaped container 1 and a cover 2 that can be set on this container. An attachment part 3 for detachable fastening of the flow reservoir onto a paint spray gun is formed on the cover. Both the container 1 and also the cover 2 with the formed attachment part 3 are preferably produced from plastic as injection-molded parts. The bowl-shaped container 1 is filled in the position shown with the cover 2 removed. Then the cover 2 can be put in place and inserted by its attachment part 3 into the attachment opening of an upside-down paint spray gun. To spray, the paint spray gun can then be inverted, so that the flow reservoir is located on the top side of the paint spray gun. To enable ventilation of the flow reservoir, e.g., a not-shown ventilation valve, which is provided on the floor 4 of the flow reservoir, can be opened, or an initially closed ventilation channel can be punctured with the help of a pin or the like. After use, by means of a reclosable ventilation valve or a reclosable ventilation opening, there is the advantage that the flow reservoir can also be used for storing paint that has not been completely used up.

The attachment part 3 shown enlarged in FIGS. 2 and 3 consists of a tubular connector 5, which is injection-molded or formed in some other way on the conical cover 2. This connector includes a front, hollow-cylindrical guidance region 6, an external thread 7 attached to this region for screwing in a conventional internal thread, and a screw-wedge element 8 connected to the external thread 7 for a quick-connect attachment of the flow reservoir to the paint spray gun. In the embodiment shown, the screw-wedge element 8 is formed by a groove 9 with a screw surface 10, which extends diagonally in the circumferential direction and which is brought into engagement with a corresponding counter-surface on a shoulder or projection of the paint spray gun. The wedge-shaped groove 9 with the screw surface 10 and the corresponding counter-surface on the paint spray gun are formed such that the flow reservoir can be fixed tightly to the paint spray gun simply by about a quarter to a half turn of the connector 5 in this way, the connector 5 is screwed down with its front end surface 11 on a corresponding sealing surface within the paint spray gun. By means of the additional external thread 7, the flow reservoir can also be used for paint spray guns that do not have an attachment that matches the screw-wedge element 8, but instead have a conventional attachment with an internal thread. Between the external thread 7 and the screw-wedge element 8, a front contact surface 12 for limiting the screw-in depth of the connector 5 is provided on the connector 5, for when the external thread 7 is used to attach the flow reservoir.

As can be seen, especially from FIG. 2, the wedge-shaped groove 9 is arranged in a shoulder 13 that extends over approximately half the circumference of the connector 5. The other half is free, so that a shoulder provided on the paint spray gun can be led into the groove 9. The groove 9 is open on its front end, while it is closed on the rear end by a ridge 14 with a contact surface 15. In this way, the quick-connect lock cannot be over-rotated.

Within the connector 5, there is a shoulder 16 shown in FIG. 3 with an annular contact surface 1 7. A filter, which is known and therefore not shown, can be inserted in the shoulder 16. The inner diameter of the shoulder 16 is somewhat greater than the outer diameter of the hollow-cylindrical guidance region 6. Therefore, the shoulder 16 can also be used for stacking the cover 2. If several covers 2 are stacked one on top of the other, the connector 5 of each lower cover 2 becomes engaged and guided by its hollow-cylindrical guidance region 6 into the shoulder 16 of the corresponding upper cover 2.

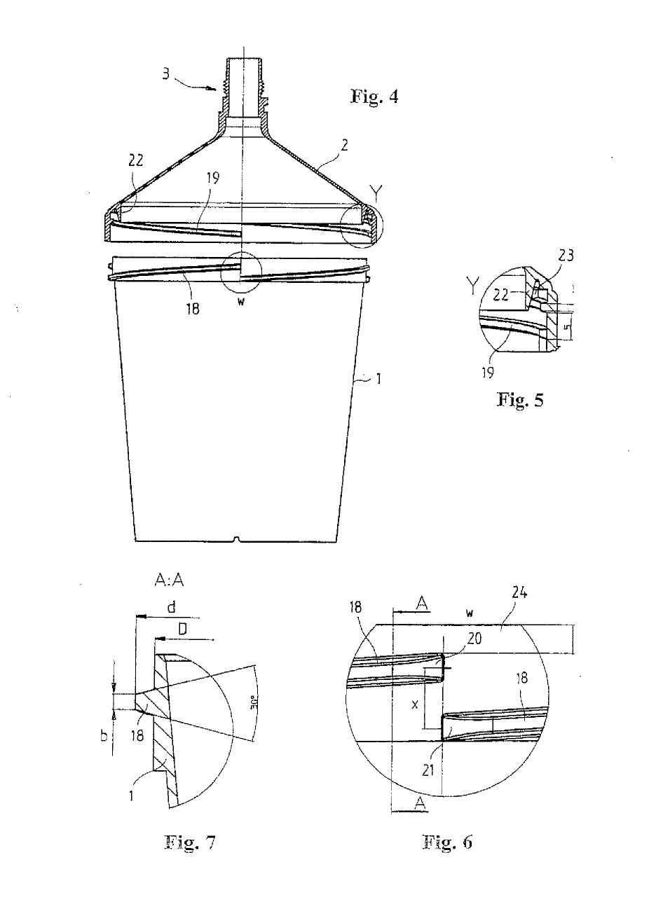

For tight connection of the container 1 and the cover 2, there is a four-part quick-connect locking thread shown in FIG. 4 with external threads 18 formed on the upper external circumference of the container 1, and corresponding internal threads 19 on the cover 2. The quick-connect locking thread is configured as a steep thread with a slope of 20 mm. Therefore, the cover 2 can be screwed tightly on the container 1 by approximately a quarter turn. The four external threads 18 on the container 1 are distributed uniformly over the outer circumference and arranged according to FIG. 6 such that the beginning 20 of one thread 18 lies directly over the end 21 of the next thread 18. The distance x between the beginning 20 of one thread and the end 21 of the other thread equals 5 mm. As is evident from FIG. 7, the thread in the configuration shown is further configured as a trapezoidal thread with a flank angle of 30°. However, the quick-connect locking thread can also be configured as a round thread, triangular thread, or a thread with another suitable profile. The major diameter d of the external thread is between 100 and 110 mm, preferably 104.6 mm. The minor diameter D of the external thread is between 90 and 105 mm, preferably 101.7 mm. The width b of the thread on the outer side is between 1.1 and 1.3 mm, preferably 1.27 mm.

On the inner side of the cover 2, a surrounding, wedge-shaped sealing ridge 22 shown in FIG. 5 is further formed, which defines a wedge-shaped annular groove 23 between its outer side and the inner side of the cover 2 for receiving the upper container edge 24. By means of the annular groove 23, which narrows like a wedge upwards in FIG. 5, the upper container edge 24 is pressed outwards onto the inner wall of the cover 2 when the cover 2 is screwed on, which results in a tightly closed connection. The sealing ridge 22 has a sufficiently large height to catch paint still located in the cover when the cover is removed and to prevent run-off into the internal thread.

The invention is not limited to the previously described embodiment shown in the drawing. For example, an insert that can be folded up can also be put into the container for receiving the paint.

1. Flow reservoir for a paint spray gun with a bowl-shaped container (1), a cover (2) that can be set on the container (1), and an attachment part (3) for direct fastening of the flow reservoir onto the paint spray gun, characterized in that the attachment part (3) consists of a connector (5) formed directly on the cover (2) with a screw-wedge element (8) for direct quick-connect attachment of the flow reservoir to the paint spray gun.

2. Flow reservoir according to claim 1, characterized in that the screw-wedge element (8) is formed by a groove (9) with a screw surface (10) extending diagonally in the circumferential direction.

3. Flow reservoir according to claim 1, characterized in that the connector (5) has an additional thread (7).

4. Flow reservoir according to claim 1, characterized in that the connector (5) has a lateral contact surface (15) for limiting the screw-in depth when the screw-wedge element (8) is used for attaching the flow reservoir.

5. Flow reservoir according to claim 3, characterized in that the connector (5) has an end contact surface (12) for limiting the screw-in depth when the thread (7) is used for attaching the flow reservoir.

6. Flow reservoir according to claim 1, characterized in that a shoulder (16) with a contact surface (17) is provided in the interior of the connector (5).

7. Flow reservoir according to claim 1, characterized in that the container (1) and the cover (2) can be tightly connected to each other by a quick-connect locking thread (18, 19).

8. Flow reservoir according to claim 7, characterized in that the quick-connect locking thread (18, 19) is a four-part steep thread with external threads (18) on the outer periphery of the container (1), and corresponding internal threads (19) on the inside of the cover (2).

9. Flow reservoir according to claim 7, characterized in that the quick-connect locking thread (18, 19) has a slope of 20 mm.

10. Flow reservoir according to claim 1, characterized in that a wedge-shaped sealing ridge (22) is formed on the inner side of the cover (2), which defines a wedge-shaped annular groove (23) between its outer side and the inner side of the cover (2) for receiving the upper container edge (24).

11. Flow reservoir according to claim 10, characterized in that the sealing ridge (22) has a sufficiently large height to catch paint in the cover (2) when the cover (2) is removed.

12. Flow reservoir according to claim 1, characterized in that an insert can be put into the container (1).
